(19) United States
(12) Patent Application Publication
(10) Pub. No.: US 2025/0370242 A1
(43) Pub. Date: Dec. 4, 2025

(54) IMAGING METHOD FOR LIGHT-TRANSMISSIVE SAMPLES, OPTICAL ARRANGEMENT AND MICROSCOPE

(71) Applicant: Carl Zeiss Microscopy GmbH, Jena (DE)

(72) Inventors: Lars Loetgering, Jena (DE); Markus Sticker, Jena (DE); Joerg Siebenmorgen, Jena (DE); Daniel Haase, Jena (DE); Ingo Kleppe, Jena (DE)

(73) Assignee: Carl Zeiss Microscopy GmbH, Jena (DE)

(21) Appl. No.: 19/226,803

(22) Filed: Jun. 3, 2025

(30) Foreign Application Priority Data
Jun. 4, 2024 (DE) 10 2024 205 127.6

(51) Int. Cl. G02B 21/14; G02B 21/00

(52) U.S. Cl. CPC G02B 21/14; G02B 21/008

(57) ABSTRACT

The difference between a well-focused image and a slightly defocused image contains information about the phase of the object. This paper describes how to retrieve this phase information from images, formed by a noncoherent imaging system. Experiments with white light from an extended source are shown. A theoretical explanation for partially coherent illumination is presented.

### CROSS-REFERENCE TO RELATED APPLICATIONS

This U.S. Patent application claims priority to German Patent Application No. DE 2024 205 127.6, filed on Jun. 4, 2024, the content of which is hereby incorporated by reference in its entirety.

### BACKGROUND OF THE INVENTION

### Field of the Invention

The invention relates to an imaging method according to the preamble of the main embodiments. The invention also relates to an optical arrangement and a microscope having such an optical arrangement.

In order to image an object to be examined, for example a biological sample, use can be made of different interactions between a utilized illumination radiation and the sample. For example, the intensity of an illumination radiation may be attenuated as a consequence of the properties of the sample (absorption). It is also possible to cause a detection radiation, for example by virtue of molecules present in the sample being excited to emit specific wavelengths by means of an illumination radiation (fluorescence). Thirdly, the influence of the sample on the formation of the wavefronts of illumination radiation (change in the phase thereof) can be used for example to create and represent contrasts in an otherwise largely contrast-free sample, as is often the case with biological samples.

For example, the latter imaging methods are advantageous in that the samples to be examined need not be stained and in that they may also be applied to virtually transparent samples. However, such phase contrasts do not offer high specificity in respect of the imaged structures in the sample.

However, phase contrasts are well suited to providing overview images, assisting with autofocusing or finding regions of interest (ROIs), for example.

### Description of Related Art

Over the recent decades, a whole host of techniques have been developed and pioneered in the field of phase contrast imaging. In recent times, increased use has been made of imaging methods that are based on computational evaluations of the captured image recordings (measurement values). In the process, a plurality of image recordings is usually captured and combined by calculation in order to obtain a resultant (phase contrast) image of the sample.

A known procedure is the transport-of-intensity equation technique, which is also referred to below as TIE for short (for example, see: Streibl, N., 1984, Phase imaging by the transport equation of intensity; Optics communications 49.1:6-10).

In order to obtain a TIE dataset, at least two images are captured along the z-axis, with the sample or the utilized objective each being moved a distance along the z-axis, moved to a respective recording position. The image recordings obtained in the process are converted into a phase contrast image, for example by solving a partial differential equation or by applying a deconvolution.

Differential phase contrast, also denoted DPC below, is another technique (e.g.: Mehta, S. B. and Sheppard, C. JR., 2009, Quantitative phase-gradient imaging at high resolution with asymmetric illumination-based differential phase contrast; Optics letters 34.13:1924-1926). In this case, the sample is illuminated at a position along the z-axis (z-position) from at least three different directions, and an image is captured in each case. If the intention is to image a volume of the sample, the relative z-position of the sample is modified for further image recordings. For the illumination from different angles, use can be made of a programmable illumination unit (PIU), which may be designed as a segmented or segmentable illumination apparatus in particular. Examples include arrays of light-emitting diodes (LEDs), digital micromirror devices (DMDs), controllable liquid crystal displays (LCDs) and variably settable stops. The captured images are combined by calculation to form a phase contrast image using a deconvolution (e.g.: Tian, L. and Waller, L., 2015, Quantitative differential phase contrast imaging in an LED array microscope, Optics Express 23:11394-11403; and Zuo, C. et al., 2020, Transport of intensity equation: a tutorial, Optics and Lasers in Engineering 135:106187).

### SUMMARY OF THE INVENTION

The problem addressed by the invention is that of proposing further imaging variants that use phase contrasts, with already existing imaging devices requiring as little technical retrofitting as possible in this respect.

### BRIEF DESCRIPTION OF THE DRAWINGS

FIG. 1 shows a schematic illustration of a first exemplary embodiment of an optical arrangement according to the invention and of a microscope.

FIG. 2 shows a schematic illustration of the method according to the invention on the basis of the arrangement from the first exemplary embodiment.

FIG. 3 shows a schematic illustration of a second exemplary embodiment of an optical arrangement according to the invention and of a microscope having a further illumination beam path.

FIG. 4 shows a schematic illustration of a third exemplary embodiment of an optical arrangement according to the invention and of a microscope having a further illumination beam path and a common objective.

FIG. 5 shows raw data from a TIE phase contrast image of adherent USO2 cells.

FIG. 6 shows a resultant TIE phase contrast image of adherent USO2 cells following the application of the method according to the invention.

FIG. 7 shows a schematic illustration of method steps for reducing strip formations and shadows present.

### DETAILED DESCRIPTION OF THE INVENTION

In respect of an imaging method for light-transmissive samples, the problem is solved by the subject matter of embodiment 1. In view of implementation in equipment, the problem is solved by the subjects of embodiments 4 and 11. The dependent embodiments specify advantageous developments.

Light-transmissive samples are understood to mean objects that are at least partially transmissive to wavelengths in the visible range and/or in the infrared range, for example cells, cell clusters and tissue of unicellular and multicellular organisms.

In the imaging method, an illumination radiation is directed along a first illumination axis at a sample to be imaged. To this end, the sample is arranged on a sample plane in advance. For example, the sample plane may be formed by a surface of a sample carrier, for example a glass plate, a petri dish or similar auxiliary means which are known in the field of laboratory work and microscopy, to which the sample is applied. To simplify matters, the sample plane and a sample space situated thereon, into which the sample arranged on the sample plane extends, are subsumed by the term sample plane below.

The illumination radiation causes a detection radiation that is collected by means of a detection optics unit, guided along a detection axis of a detection beam path and captured as an image recording by means of a detector. In particular, a detection radiation is an illumination radiation that passes through the sample and is modified in terms of its phase as a consequence of the substances and structures contained in the sample. 2D detectors that allow a spatially resolved capture of the incident detection radiation are used as a detector, for example(s) CMOS and CCD chips or arrays of photodiodes, for example SPAD arrays (single photon avalanche array).

Within the scope of the imaging method, a plurality of image recordings is captured in accordance with the transport-of-intensity equation (TIE) technique or the differential phase contrast (DPC) technique.

In order to capture the plurality of image recordings by means of the transport-of-intensity equation technique (also referred to as TIE technique or TIE for short below), the sample is moved along the sample plane and at a non-zero angle with respect to the focal plane.

Within the scope of the imaging method, in particular according to the TIE technique, a plurality of image recordings is captured in different object planes of the sample, at least a majority thereof being located slightly outside of the focal plane of the detection optics unit and hence being defocused. For example, the distances between the object planes are chosen from a range between 300 nm and 100 μm, for example between 1 μm and 10 μm. However, this encompasses situations in which a (small, <50%) proportion of an object plane is nevertheless located in the focal plane.

In order to capture a plurality of the image recordings by means of the differential phase contrast technique (also referred to as DPC technique or DPC for short below), the sample is illuminated by illumination radiation at different illumination angles. In the DPC technique variant of the method, it is optionally also possible to move the sample along the sample plane and at a non-zero angle with respect to the focal plane and capture a first or a further image recording in accordance with the DPC technique at a current position of the sample reached thus.

The captured image recordings from in each case one of the aforementioned techniques are subsequently combined by calculation in order to obtain a resultant image of the sample, in particular a phase contrast image.

An imaging method according to the invention is characterized in that a detection angle which is formed between the detection axis and the sample plane and at which the detection axis is directed into the sample plane and into a sample present there is chosen from a range between 20° and 80° such that a focal plane of the detection optics unit is also inclined relative to the sample plane, and as a result the respective relevant object plane is captured in an image plane that is inclined relative to the sample plane.

For performing the TIE technique and optionally when implementing the DPC technique, the sample is moved parallel to the sample plane and at a non-zero angle with respect to the focal plane. As a result, a currently captured object plane is pushed out of the focal plane by a distance (increment for example selected from a range between 10 and 100 μm; see above). The object planes in each case captured successively in time (sequentially) are also aligned parallel to one another.

Corresponding relative movements between the sample and the detection optics unit are also possible in further configurations of the invention. In order to assign to one another the individual locations within the image recordings captured at an angle, said locations are converted into a normalized position parallel to the sample plane (normalized z-stack). Such a normalized z-stack is the starting point for combining the image recording by calculation in order to generate the resultant image (see below).

The image recordings of a normalized z-stack may optionally also be examined for the presence of artificial stripes and/or shadows, and these may be reduced by the application of appropriate corrections.

Should the imaging method according to the invention be carried out according to the differential phase contrast technique, each object plane to be captured is illuminated by illumination radiation at different illumination angles. For example, a controllably switchable illumination array, as will be described in more detail below, may be used to this end. One image recording is captured for each illumination angle.

The central concept of the invention lies in inclining the detection axis relative to the sample plane and carrying out a relative movement parallel to the sample plane (referred to as “horizontal” hereinafter to simplify matters) between the focal plane of the detection optics unit and the sample to be imaged, in order to switch between the respective positions for the image recordings. The oblique position in combination with the horizontal movement differs significantly from the procedure according to the prior art, in which there is an orthogonal and not an oblique relative movement, i.e. a displacement along the detection axis. The procedure according to the invention requires measures for compensating for the resultant oblique position of the image recordings but at the same time opens up significant technical advantages. For example, these are found in the usability of or simple retrofitting for available optical arrangements for capturing images, and in a technically simple combinability with already envisaged imaging methods.

Should the sample be displaced a distance parallel to the sample plane, the sample region previously in the focal plane is now defocused.

For example, in order to create a contrast image using TIE, a first image of a first object plane is captured, the latter having been moved away from the focal plane by 2 μm, for example. In a second object plane (n=2), at least one second image is captured, for example at a distance of 4 μm from the focal plane, after the sample was displaced horizontally in the sample plane by a further step with an increment of 2 μm. The same procedure can be used for each further n-th object plane.

On account of the inclination of the detection axis, the captured image recordings are also inclined. In order to create the desired contrast images, the image recordings captured with an inclination must firstly be converted into a normalized z-stack of image recordings. A normalized z-stack is composed of image recordings whose image planes extend in the xy-plane and which, at least virtually, are strung together along the z-axis in a manner parallel to one another and without a lateral offset. The resultant image is created in this coordinate system (“sample carrier coordinates”).

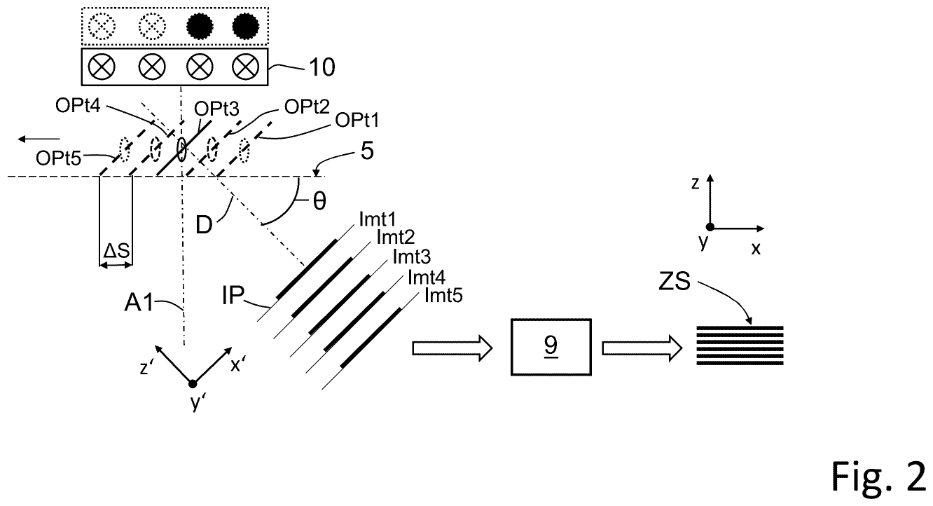

The individual steps of such a transformation T may be referred to as shearing or transverse offset (A), scaling (B) and rotation (C) (see also FIG. 2).

Mathematically, these transformations may be expressed as follows:

$$A = [ \begin{matrix}1 & 0 & 0 & 0 \\ 0 & 1 & 0 & 0 \\ 0 & a & 1 & 0 \\ 0 & 0 & 0 & 1\end{matrix} ] ,$$

$$B = [ \begin{matrix}1 & 0 & 0 & 0 \\ 0 & 1 & 0 & 0 \\ 0 & 0 & b & 0 \\ 0 & 0 & 0 & 1\end{matrix} ] ,$$

$$and$$

$$C = [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] ,$$

where a is a correction value for the transverse offset in the xz-plane (see FIG. 2). The term b is a parameter for flexibly adjusting the pixel size of the sample in the resultant image, taking into account the increment between the object planes. The detection angle θ is non-zero.

In a preferred configuration of the invention, a transfer function of the form

$$WOTF ( k ) = \int S ( {k}^{′} ) {P}^{*} ( {k}^{′} ) P ( {k}^{′} + k ) {dk}^{′}$$

is applied to the normalized z-stack, where
k=(kₓ, k_{y}) and k′=(k′ₓ, k′_{y}) are spatial frequencies; and

S denotes the shape of the light source and P denotes the shape of the pupil of the detection optics unit (Streibl, N., 1984, Phase imaging by the transport equation of intensity; Optics communications 49.1:6-10). In this case, the abbreviation “WOTF” stands for “weak object transfer function”.

Should different illumination patterns and different defocusing states be taken into account when applying the WOTF, there is a need for two additional indices to describe this. What is known as a bi-index WOTF (bi-index weak object transfer function) of the form

$${WOTF}_{m , n} ( k ) = \int {S}_{m} ( {k}^{′} ) {P}_{n}^{*} ( {k}^{′} ) {P}_{n} ( {k}^{′} + k ) {dk}^{′}$$

may be used in this case, where the index m denotes the illumination pattern, and the index n denotes the defocusing state. The expression Sₘ(k) describes the m-th illumination pattern, which may for example be provided by a controllable illumination array. The defocusing state may be taken into account by virtue of adding a suitable quadratic or spherical function:

$${P}_{n} ( k ) = P ( k ) exp [ j \cdot {z}_{n} \cdot \sqrt{{k}_{0}^{2} - {k}_{x}^{2} - {k}_{y}^{2}} ] ,$$

where zₙ specifies the displacement of the structure relative to the focal plane when the n-th object plane is captured.

The terms Sₘ(k′) and Pₙ (k) contain possible modified illumination patterns and pupil states, respectively, which may arise from the mutually inclined arrangement of the relevant optical axes. A pupil state is the aperture of the pupil multiplied by the aberrations of the objective and optionally by additional aberrations due to the light path to the sample, e.g. defocus.

An amplitude transfer function (ATF) and a phase transfer function (PTF) may be defined as follows:

$${ATF}_{m , n} ( k ) = Real [ {WOTF}_{m , n} ( k ) ]$$

$$and$$

$${PTF}_{m , n} ( k ) = - Imag [ {WOTF}_{m , n} ( k ) ] .$$

In this case, it is possible to give no further consideration to the amplitude transfer function ATF for weakly absorbing samples or aberration-free optical systems.

In a partially coherent optical arrangement, for example in a corresponding microscope, it is possible to perform a two-dimensional Fourier transform of an image FT[I] in the spatial domain:

$$FT [ {I}_{m , n} ] ( k ) = o + {PTF}_{m , n} ( k ) \cdot FT [ ϕ ] ( k ) , for all m = 1 , … , M ; n = 1 , … , N .$$

In this case, o is a constant offset while ¢ specifies an unknown phase distribution that needs to be estimated.

It should be observed that the captured image recordings of the respective object planes are based on a multiplicity of equations. In particular, each combination of an illumination pattern (m) and a defocusing state (n) is described in a separate equation.

In order to reduce disadvantageous background signals in the image recordings, it is possible to form differences between pairs of indices (m, n) and (m′, n′) in a possible configuration of the invention. In this context,

$$FT [ {dI}_{m , n , {m}^{′} , {n}^{′}} ] ( k ) = {dPTF}_{m , n , {m}^{′} , n ′} ( k ) \cdot FT [ ϕ ] ( k )$$

is obtained. In this context,

$${dI}_{m , n , {m}^{′} , {n}^{′}}$$

is used to define the difference in the intensities of the images.

A difference in the phase transfer function PTF is ascertained by:

$${dPTF}_{m , n , {m}^{′} , {n}^{′}} ( k ) = {PTF}_{m , n} ( k ) - {dPTF}_{{m}^{′} , {n}^{′}} ( k ) .$$

These equations may be solved in view of the phase distribution ¢ by applying deconvolution techniques. Thus, the equations specified above may be solved in the form of a least squares problem:

$$arg {min}_{ϕ} {\sum }_{m , n , {m}^{′} , {n}^{′}} {‖ FT [ {dI}_{m , n , {m}^{′} , {n}^{′}} ] ( k ) - {dPTF}_{m , n , {m}^{′} , {n}^{′}} ( k ) \cdot FT [ ϕ ] ( k ) ‖}_{2}^{2} + α {‖ FT [ ϕ ] ( k ) ‖}_{2}^{2} , where {‖ … ‖}_{2}^{2}$$

is the sum of the squares over all pixels in the Fourier domain. All suitable combinations of pairs (m, n) and (m′, n′) are included, with these being chosen such that the offset o can be cancelled. The last expression is a regulation term, which is determined by the parameter a.

For the case α=0, an optimal estimate of the phase distribution can be obtained by:

$$ϕ = iFT [ \frac{{\sum }_{m , n , {m}^{′} , {n}^{′}} {dPTF}_{m , n , {m}^{′} , {n}^{′}}^{*} \cdot FT [ {dI}_{m , n , {m}^{′} , {n}^{′}} ]}{{\sum }_{m , n , {m}^{′} , {n}^{′}} {\vert {dPTF}_{m , n , {m}^{′} , {n}^{′}} \vert}^{2}} ] .$$

where iFT [ . . . ] denotes the Fourier transform. To simplify the expression of the formula, the dependence of dPTF*_{m,n,m′,n′} and FT[dI_{m,n,m′,n′}] on the spatial frequency vector k was omitted.

It is particularly demanding to perform the deconvolution in the term of the denominator

$$d ( k ) = {\sum }_{m , n , {m}^{′} , {n}^{′}} {\vert {dPTF}_{m , n , {m}^{′} , {n}^{′}} ( k ) \vert}^{2} ,$$

since this may potentially have zero crossings. Division by zero or by values close to zero leads to an increase in background signals (noise) or to numerical problems. To avoid these problems, a term (α>0) is added to the denominator:

$$ϕ = iFT [ \frac{{\sum }_{m , n , {m}^{′} , {n}^{′}} {dPTF}_{m , n , {m}^{′} , {n}^{′}}^{*} \cdot FT [ {dI}_{m , n , {m}^{′} , {n}^{′}} ]}{{\sum }_{m , n , {m}^{′} , {n}^{′}} {\vert {dPTF}_{m , n , {m}^{′} , {n}^{′}} \vert}^{2} + α} ] .$$

In a further configuration of the method according to the invention, TIE may serve as an approximation for the phase transfer function PTF.

The TIE, which applies to quasi-coherent (light) sources, may be considered to be a suitable approximation of the PTF if the size of the illumination device is small or, more accurately, if the numerical aperture of the illumination <0.5 the numerical aperture of the detection. In that case, it is possible to approximate the WOTF using a delta function, and so the following applies:

$${WOTF}_{m , n} ( k ) = {P}_{n}^{*} ( 0 ) {P}_{n} ( k ) .$$

If the increments between the captured object planes are chosen to be small, i.e. if there is little defocusing in the image recordings, further simplifications can be made using a quadratic function:

$${WOTF}_{m , n} ( k ) = j {\vert k \vert}^{2}$$

This procedure is used quite frequently as paraxial approximation of the transfer function of the TIE (Streibl, N., 1984, Phase imaging by the transport equation of intensity; Optics communications 49.1:6-10).

In addition to the imaging method, the invention comprises an optical arrangement.

The latter comprises a sample stage for positioning a sample to be imaged, with a sample plane being defined by the sample stage. An illumination device is present, by means of which an illumination radiation is directed or can be directed along a first illumination axis of a first illumination beam path at the sample plane, with the first illumination axis being directed substantially perpendicularly at the sample plane.

A detection optics unit serves for collecting and guiding a detection radiation, caused in the sample by the effect of the illumination radiation, along a detection axis of a detection beam path. A detector is present for capturing the detection radiation as an image recording. In this context, a plurality of image recordings may be captured in different object planes of the sample, which are optionally located outside of the focal plane of the detection optics unit and hence being defocused.

A controllable arrangement of a plurality of individual light sources (illumination array), the illumination radiation of which is directed along a first illumination axis at the sample, is advantageously present as a first illumination source. The upshot is that illumination radiation is emitted in the direction of the sample plane at different angles depending on which of the individual light sources in the illumination array are switched on at a given time. Should individual light sources be selected and controlled symmetrically around the first illumination axis, the sample is illuminated uniformly and without a preferred angle.

The optical arrangement comprises an evaluation unit that is configured to combine the plurality of image recordings with one another by calculation and to obtain a resultant phase contrast image of the sample.

The optical arrangement according to the invention is characterized in that a detection angle which is formed between the detection axis and the sample plane and at which the detection axis is directed into the sample or into the sample plane and into the sample space present above the sample plane is chosen from a range between 20° and 80°, in particular between 30° and 60°, such that the focal plane of the detection optics unit is inclined relative to the sample plane, and as a result both the object planes and the image planes of the captured image recordings are inclined relative to the sample plane. The evaluation unit is configured to convert the image recordings captured in inclined fashion into a normalized position parallel to the sample plane and in particular into a corrected image stack (normalized z-stack) in respect of their position in the xy-plane. The phase contrast image is ascertained, in particular calculated, using the normalized z-stack as a starting point.

Thus, the detection axis and a surface normal of the sample carrier, and accordingly of the sample plane, are not parallel to one another but inclined to one another (“non-coplanar”).

In a possible embodiment of the optical arrangement, the first illumination axis and the detection axis are directed into the sample plane from different sides of the sample stage.

In a further embodiment of the invention, the detection axis is directed into the sample plane (right) through the sample stage. In this way, it is possible to maintain a large angle between the first illumination axis and the detection axis and moreover keep space above the sample plane available, for example for a manipulation of the sample, for example by arranging the detection optics unit below the sample carrier (inverted arrangement).

The inverted arrangement of the detection optics unit in particular opens up the possibility of providing a further illumination beam path. The latter is directed into the sample plane, for example through the sample stage, with a further illumination axis of the further illumination beam path intersecting the detection axis in the sample plane and forming an angle of 90° with the detection axis. The further illumination beam therefore extends parallel to the focal plane and advantageously intersects the detection axis precisely in the region of the focal plane. Such a configuration allows regions of the sample impinged upon by an illumination radiation of the further illumination beam path to be imaged sharply by means of the detection optics unit. Advantageously, the further illumination beam path likewise has an inverted arrangement.

Disadvantages, in particular aberrations, caused as a consequence of an oblique illumination or an oblique detection by a sample carrier that is transparent (transmissive) to the relevant wavelengths may or must be reduced by the use of suitable optical elements and/or by computation.

In the case of a 90° arrangement of the further illumination axis and the detection axis, as described above, the illumination radiation of the further illumination beam path may, in an advantageous embodiment of the invention, be shaped in the sample plane to form a light sheet that extends transversely to the detection axis.

Thus, in a technically simple fashion, the invention allows not only the application of imaging techniques by way of a phase contrast but also the combination thereof with further techniques, for example the excitation of fluorescence using suitable wavelengths of the further illumination radiation.

The further illumination beam path and the inclined detection axis may be guided in a common objective in a further embodiment of the optical arrangement according to the invention. The illumination of the sample and the capture of the detection radiation are implemented using the common objective when the optical arrangement operates in such a mode of operation.

It is therefore advantageous for a controller to be present, by means of which the illumination via the first illumination beam path (first mode of operation) or via the further illumination beam path (second mode of operation) is controlled and which moreover, independently of the embodiment and number of the illumination beam paths, controls the evaluation unit in order to initiate an evaluation routine for the respective captured image recordings that is assigned depending on the currently used illumination beam path. In this way, it is possible to vary both the generation of the image recordings and the evaluation of the captured measurement values (image data).

The controller and the evaluation unit may be compartments of a computer. For example, the controller may also be realized in the form of a microcontroller or a field programmable gate array (FPGA).

The optical arrangement according to the invention can be a constituent part of a microscope. For example, an available light sheet microscope may be retrofitted with a segmented or segmentable illumination device, and an evaluation unit may be accordingly configured in order to perform the method according to the invention.

The invention is explained in detail below on the basis of exemplary embodiments and with reference to drawings.

In the exemplary embodiments below, identical technical elements are provided with the same reference signs.

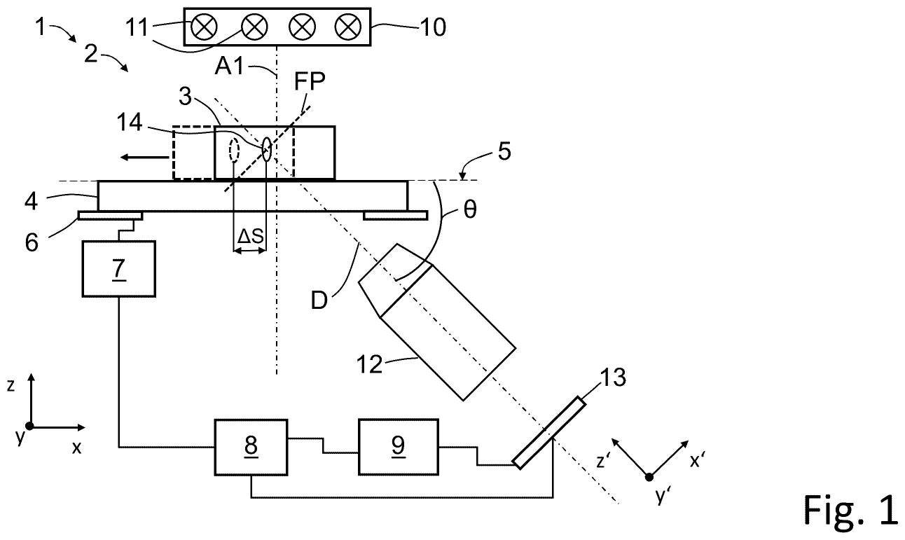

FIG. 1 shows a schematic illustration of a first exemplary embodiment of an optical arrangement 2 according to the invention, which is a constituent part of a microscope 1. A sample 3 is arranged on a sample carrier 4. The surface of the sample carrier 4 that points upwards in the drawing and faces a first illumination device 10 defines a sample plane 5, which is referred to below. The space above the sample plane 5, in which the sample 3 is arranged or can be arranged, is also referred to as a sample space. The sample carrier 4 is held on a sample stage 6 that can be moved along the axes x, y, z of a Cartesian coordinate system in controlled fashion by means of a drive 7. The sample carrier 4 can be displaced with a controllable increment ΔS in the direction of the x-axis (also referred to as horizontally) for the purpose of performing the imaging method.

The effect of such a horizontal displacement along the x-axis is shown by way of example on the basis of a fictitious structure 14 of the sample 3. Initially, the structure 14 represented by an oval is situated in the focal plane FP and can therefore be imaged in focus. A displacement in the direction of the x-axis within increment ΔS leads to the structure 14 being moved out of the focal plane FP, and so said structure can only still be imaged in blurred (defocused) fashion (shown using dashed lines).

By means of the first illumination device 10 in the form of an arrangement of a number of individual light sources 11 (illumination array 10), a first illumination radiation may be directed in reflected light setup at the sample 3 along a first illumination axis A1, which moreover, as a simplification, represents a first illumination beam path. The illumination array 10 is controllable by means of a controller 8, in such a way that each of the individual light sources 11 or segments of the illumination array 10 may be switched on or off. It is therefore possible by means of the illumination array 10 to direct the first illumination radiation at the sample 3, for example in extensive fashion or at selected angles (for example, see FIG. 2).

A radiation entering or passing through the sample 3 may be collected by means of the detection optics unit 12 and may be steered along a detection beam path D (detection axis D) to a detector 13, where it may be captured in the form of measurement values. The detection axis D of the detection beam path D or of the detection optics unit 12 is directed through the sample carrier 4 into the sample 3 at a detection angle θ of 45°, for example. In this case, the detection angle θ is the smaller angle formed between the detection axis D and the sample plane 5. As a consequence of the inclined detection axis D, a focal plane FP of the detection optics unit 12 and an image plane IP of the detector 13 are also inclined vis-à-vis the sample plane 5. It is possible to take account of the inclined alignment using a coordinate system x′, y′, z′, which may be provided by way of a rotation of the previous coordinate system about the y-axis through an angular value corresponding to 0. In further embodiments, the detection angle θ may be chosen from a range between 20° and 80°.

The drive 7, the controller 8, the evaluation unit 9, the illumination array 10 and the detector 13 are suitably connected to one another for the exchange of data.

The method according to the invention can be explained on the basis of the arrangement of the first exemplary embodiment and the TIE technique (FIG. 2). All technical elements not required for the explanation have been omitted to provide a better overview. The sample 3 to be imaged is illuminated along the first illumination axis A1 by means of the first illumination radiation. The sample 3 is displaced in the direction of the x-axis with an increment ΔS. After one step, an image recording Imtn of an object plane OP is captured, wherein the added index tn (n=1, 2, . . . , n) represents respective recording times.

At least two slightly defocused image recordings must be available in order to be able to apply the TIE methodology. The path of the structure 14 along the x-axis has been shown for illustrative purposes. The defocusing is symbolized on the basis of the intensity of the boundary of the structure 14.

In the example shown, a first image recording Imt1 of the object plane OPt1 may be implemented at a time t1. At a time t2, the sample 3 has been displaced horizontally in the direction of the arrow by an increment ΔS, and a second image recording Imt2 of the object plane OPt2 may be captured. The defocusing of the second image recording Imt2 is less than that of the first image recording Imt1. A third image recording Imt3 at a time t3 is imaged in focus since the structure 14 is situated within the focal plane FP at that time. In the event of a further displacement of the sample 3 in the direction of the x-axis, the image recordings Imt4 and Imt5 may be captured at the times t4 and t5, respectively.

The image recordings Imt1 to Imt5 captured in each case are shown as an inclined stack.

The image recordings Imt1 to Imt5 captured by means of the detector 13 are transmitted to the evaluation unit 9. The latter is configured to transform the image recordings Imt1 to Imt5 captured in inclined fashion relative to the sample plane 5 into a normalized z-Stack ZS.

Should the differential phase contrast (DPC) methodology be applied, the illumination array 10 may be controlled at each recording time tn, in such a way that the sample 3 is illuminated from different angles. In FIG. 2, this is illustrated by the first illumination device 10 with a dashed boundary, in which the two individual light sources 11 depicted to the right are switched off. As a result, illumination radiation is directed at the sample 3 at an angle of approximately −20° relative to the illumination axis A1 shown. A corresponding statement applies if other individual light sources 11 are switched on. Thus, the sole use of the two individual light sources 11 shown at the right would cause an illumination angle of approximately +20°.

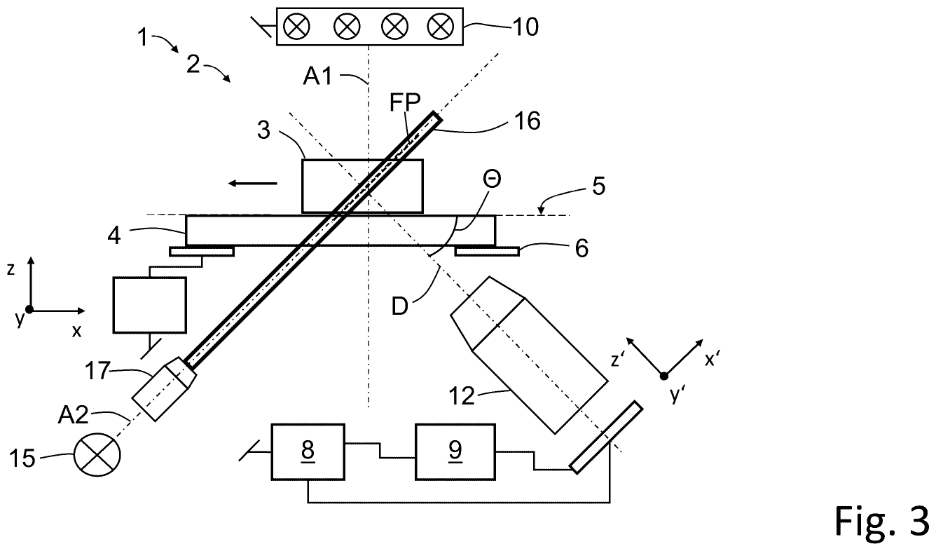

In a second exemplary embodiment of an optical arrangement 2 according to the invention and of a microscope 1, a further illumination beam path A2 is present; it is directed through the sample carrier 4 into the sample space at an angle of e.g. −45° with respect to the sample plane 5 by means of a further illumination optics unit 17 and intersects the focal plane FP in said sample space (FIG. 3).

The illumination radiation of the further illumination beam path A2 is provided by a further illumination device 15 and is shaped to form a light sheet 16, the plane of which is perpendicular to the plane of the drawing. For example, a light sheet 16 can be created using a cylindrical lens and/or a scanner (neither of which are shown).

The further illumination axis A2 and the detection axis D form an angle of 90°, and so the focal plane FP is parallel to the plane of the light sheet 16 and extends in the latter. A region of the light sheet 16 can be imaged in focus by means of the detection optics unit 12. In this configuration of the microscope 1, an existing inverted light sheet microscope for example has been equipped or retrofitted with the additional function of phase contrast imaging by means of TIE and/or DPC techniques.

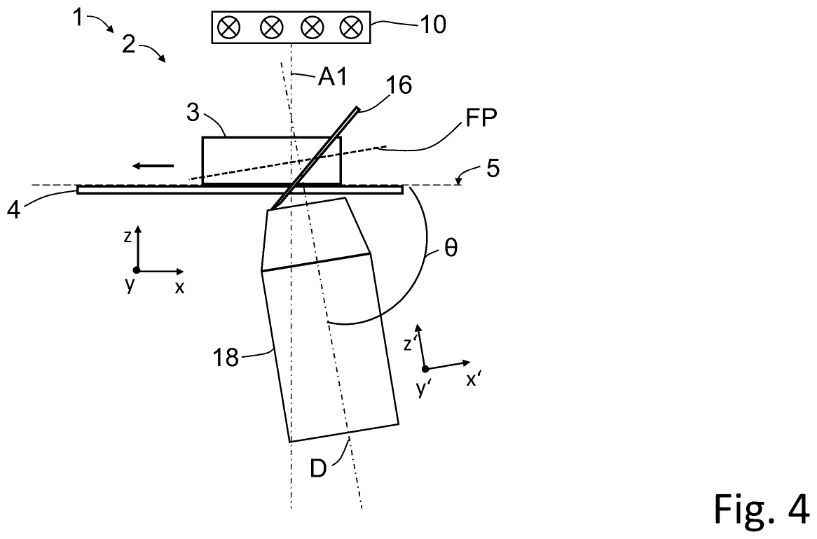

In a third exemplary embodiment, a further illumination beam path A2 is also present but illumination by means of the further illumination radiation and collection of the detection radiation are implemented using a common objective 18 (FIG. 4). To this end, the illumination radiation away from the optical axis of the common objective 18 is directed into an entrance pupil of the common objective 18. As a result, the illumination radiation then emerges at an angle to the optical axis of the common objective 18. The entrance location in the entrance pupil is chosen such that the further illumination radiation emerging obliquely from the common objective 18 and the detection axis D intersect in the sample space. An oblique light sheet 16 is created in the sample space as a result of the illumination radiation being shaped in advance by means of optical elements and/or accordingly being scanned back and forth by means of a scanner. The detection can be implemented at right angles to the created light sheet 16 by virtue of detection radiation accordingly also being collected away from the optical axis of the common objective 18. This procedure is known from the prior art (for example, see DE 10 2020 209 889 A1 and U.S. Pat. No. 8,582,203 B2).

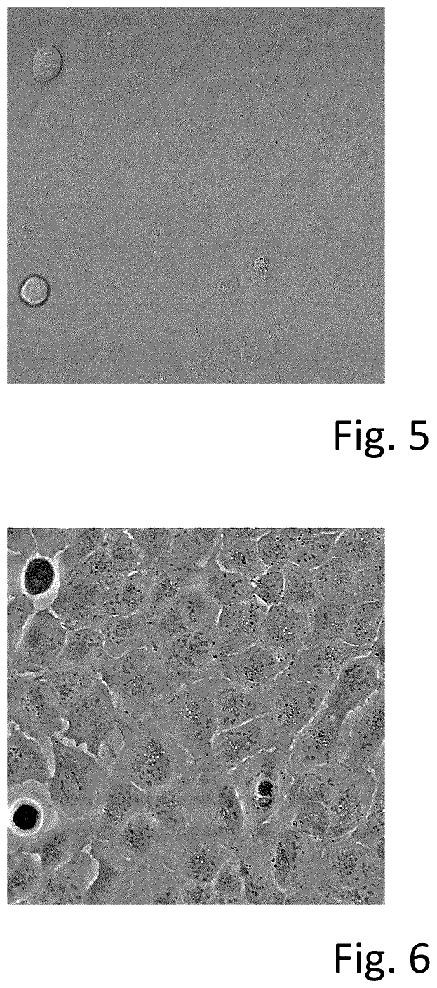

The two FIGS. 5 and 6 illustrate the advantages of the invention on the basis of the TIE technique. FIG. 5 shows a wide field image of adherent USO2 cells—an osteosarcoma cell line—in accordance with their raw data. All that can be identified is a few cell constituents in a low-contrast matrix.

In FIG. 6, the image recordings are combined by calculation in accordance with the TIE methodology and in accordance with the method according to the invention. The resultant image shows a plurality of cell constituents with a high contrast.

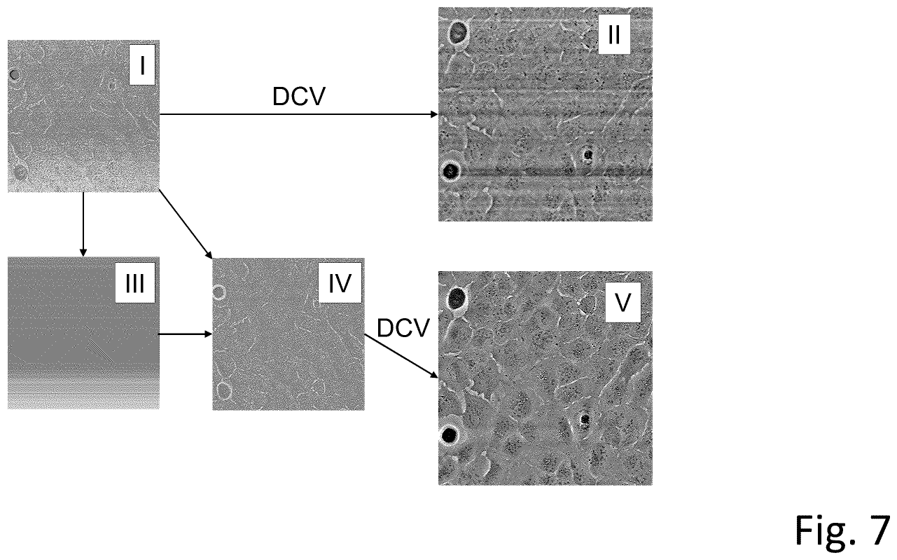

Possible further method steps for improving the quality of the resultant image are shown in an overview sketch in FIG. 7.

Unwanted stripes may form during the transformation of the stack of inclined image recordings into a normalized z-Stack ZS. Reasons for this may be found for example in irregularities or errors when moving the sample stage 6 in the direction of the x-axis and/or may occur on account of pixel errors of the detector 13. For example, pixel errors are non-active (“dead pixels”) detector elements or detector elements continuously outputting measurement values (“hot pixels”) of the detector 13. Such errors are distributed in the xy-plane (“smeared”) as a consequence of the transformation. Unwanted stripes may have a disadvantageous effect on the evaluation of the resultant image; however, they are identifiable using mathematical methods and can be removed. For example, a mean value, median or higher order statistics of the image may be estimated and used to reduce the errors, for example by subtraction or division.

Accordingly, a correction can be undertaken in addition to that or as an alternative, by means of which unwanted influences of ambient and stray light are reduced.

Using image recordings Imt1 to Imt5 (Image I) previously converted into a normalized z-Stack ZS as a starting point, a deconvolution DCV can be used to obtain a resultant Image II, but this may contain stripes and/or shadows.

By contrast, if sums are formed along the columns of the underlying data array when Image I is used as a starting point, stripes and shadows present can be estimated on the basis thereof, and an error matrix (Image III) can be created and provided. A normalized z-Stack ZS of corrected image recordings Imt1 to IMt5 (Image IV) is generated by means of the error matrix applied to Image I, for example by means of subtraction. If a deconvolution DCV is applied to Image IV, a resultant image V is obtained, in which errors such as stripes and/or shadows are reduced.

### REFERENCE SIGNS

1 Microscope
2 Optical arrangement
3 Sample
4 Sample carrier
Sample plane
6 Sample stage
7 Drive
8 Control unit
9 Evaluation unit
10 First illumination device
11 Individual light source
12 Detection objective/detection optics unit
13 Detector
14 Structure
15 Further illumination device
16 Further illumination radiation/light sheet
17 Further illumination optics unit
18 Common objective
θ Detection angle
A1 First illumination axis/first illumination beam path
A2 Further illumination axis/further illumination beam path
D Detection axis/detection beam path
FP Focal plane
Im, Imtn Image recording
IP Image plane
OP Object plane
ΔS Increment
ZS Normalized z-stack

1. An imaging method for light-transmissive samples, the method comprising: directing an illumination radiation along a first illumination axis (A1) at a sample to be imaged arranged in a sample plane;
collecting a detection radiation caused by the illumination radiation by a detection optics unit, guided along a detection axis of a detection beam path (D) and captured as an image recording (Im) by a detector,
capturing a plurality of image recordings (Imtn) in accordance with a transport-of-intensity equation (TIE) technique or a differential phase contrast (DPC) technique,
wherein
the sample is moved along the sample plane and at a non-zero angle with respect to a focal plane (FP) for the purpose of capturing the plurality of image recordings (Imtn) by the transport-of-intensity equation (TIE) technique; or
the sample is illuminated by illumination radiation at different illumination angles for the purpose of capturing the plurality of image recordings (Imtn) by the differential phase contrast (DPC) technique; and
the plurality of image recordings (Imtn) from one of the techniques is combined by calculation in order to obtain a resultant phase contrast image of the sample,
wherein
a detection angle (θ) which is formed between the detection axis (D) and the sample plane and at which the detection axis (D) is directed into the sample is chosen from a range between 20° and 80° that the focal plane (FP) of the detection optics unit is inclined relative to the sample plane, and as a result the plurality of image recordings (Imtn) is captured in a manner inclined relative to the sample plane;
the captured inclined plurality of image recordings (Imtn) is converted into a normalized position parallel to the sample plane; and
the phase contrast image is ascertained using the normalized position as a starting point.

2. The imaging method according to claim 1, comprising:
applying, in order to generate a resultant image, a transfer function of the form
$$WOTF ( k ) = \int S ( {k}^{′} ) {P}^{*} ( {k}^{′} ) P ( {k}^{′} + k ) {dk}^{′} ,$$
where
k=(kₓ, k_{y}) and
k′=(k′ₓ, k′_{y}) are spatial frequencies; and
S denotes a shape of a light source, and P denotes a shape of a pupil in the detection optics unit.

3. The imaging method according to claim 1, comprising:
aligning the first illumination axis (A1) and the detection axis (D) relative to one another that they form an angle in a range of 110° to 170°.

4. An optical arrangement, comprising:
a sample stage for positioning a sample to be imaged, with a sample plane being defined by the sample stage;
an illumination device by which an illumination radiation is directed or is configured to be directed along a first illumination axis (A1) of a first illumination beam path into the sample plane, with the first illumination axis (A1) being directed perpendicularly at the sample plane;
a detection optics unit for collecting and guiding a detection radiation, caused in the sample by the effect of the illumination radiation, along a detection axis (D) of a detection beam path (D);
a detector for capturing the detection radiation as an image recording (Im), to capture a plurality of image recordings (Imtn) in different object planes (OPtn) of the sample; and
an evaluation unit that is configured to combine the plurality of image recordings (Imtn) with one another by calculation and to obtain a resultant phase contrast image of the sample;
wherein
a detection angle (θ) which is formed between the detection axis (D) and the sample plane and at which the detection axis (D) is directed into the sample plane is chosen from a range between 20° and 80° that the focal plane (FP) of the detection optics unit is inclined relative to the sample plane, and as a result the plurality of image recordings (Imtn) is captured in a manner inclined relative to the sample plane; and
the evaluation unit is configured to convert the plurality of image recordings (Imtn) captured in inclined fashion into a normalized position parallel to the sample plane.

5. The optical arrangement according to claim 4, wherein the first illumination axis (A1) and the detection axis (D) are directed at the sample plane from different sides of the sample stage.

6. The optical arrangement according to claim 4, wherein the detection axis (D) is directed into the sample plane through the sample stage.

7. The optical arrangement according to claim 5, further comprising:
an illumination beam path (A2) which is directed into the sample plane through the sample stage, with a further illumination axis (A2) of the further illumination beam path (A2) intersecting the detection axis (D) in the sample plane and forming an angle of 90° with the detection axis (D).

8. The optical arrangement according to claim 7, wherein the illumination radiation of the further illumination beam path (A2) is shaped in the sample plane to form a light sheet that extends transversely to the detection axis (D).

9. The optical arrangement according to claim 7, wherein both the further illumination beam path (A2) and the detection beam path (D) are guided through a common objective such that the illumination of the sample and the capture of the detection radiation are implemented using the common objective.

10. The optical arrangement according to claim 7, comprising:
a controller, by which the illumination via the first illumination beam path (A1) or via the further illumination beam path (A2) is controlled and which moreover controls the evaluation unit in order to initiate an evaluation routine for the respective captured image recordings (Imtn) that is assigned depending on the currently used illumination beam path (A1, A2).

11. A microscope, comprising:
an optical arrangement according to claim 4.
